(19) United States
(12) Patent Application Publication
(10) Pub. No.: US 2024/0278630 A1
(43) Pub. Date: Aug. 22, 2024

(54) STORAGE CAVITY FOR A CAR SUNSHADE

(71) Applicant: Guangzhouyiqiandao Technology Co., Ltd, Guangzhou (CN)

(72) Inventor: Xinxing Yi, Shaoyang (CN)

(21) Appl. No.: 18/125,641

(22) Filed: Mar. 23, 2023

(30) Foreign Application Priority Data
Feb. 16, 2023 (CN) 2023101207751

(51) Int. Cl. B60J 11/04; B60R 11/00

(52) U.S. Cl. CPC B60J 11/04; B60R 11/00; B60R 2011/0082

(57) ABSTRACT

A storage cavity for a car sunshade, the storage cavity comprises a lower member, an upper member, a connector, and the storage cavity is an integrally formed structure, the two ends of the connector are respectively connected with the lower member and upper member; the lower member comprises a lower left arc frame, a lower right arc frame, and a lower connecting plate, the upper member comprises an upper left arc frame, an upper right arc frame, and an upper connecting plate, the upper left arc frame, the lower left arc frame and the connector form the left storage cavity, the upper right arc frame, the lower right arc frame and the connector form the right storage cavity; the connector comprises a left connector and a right connector, the left connector is connected to the right connector, their ends away from each other are respectively provided with open slots.

### 1. TECHNICAL FIELD

The invention relates to the technical field of the sunshade, in particular to a storage cavity for a car sunshade.

### 2. BACKGROUND ART

At present, the number of cars has grown very rapidly in Global, due to the scarcity of urban space, it is impossible to build enough garages for parking vehicles, so many people have to park their cars on the roadside or outdoors, when the summer comes, the hot sun shines on the cars parked outdoors for a long time, because of the high heat storage capacity of the metal shell of the car, and after a long period of exposure, each car is like an oven, which intensifies the urban heat island effect;

At the same time, the continuous high temperature increases the internal temperature of the car, even reaching above 60° ° C., at such a temperature, the interior materials of the car will continue to volatilize many harmful substances, even after opening the door for ventilation, they will still be inhaled into the human body, causing damage to human health;

In addition, long-term exposure to the sun will seriously age the internal and external materials of the car, which not only increases the waste caused by replacing parts, but more seriously may cause the internal circuits of the car to catch fire, causing the car to spontaneously ignite and major accidents;

In order to solve the problem of the car being exposed to the sun in the open air, a variety of vehicle-mounted sunshade devices have appeared on the market, however, when the traditional sunshade is used every time, due to the relatively large size, it is inconvenient to use and store, resulting in low frequency of use, and the common sunshade storage device is a rectangular box, which is stored by folding the umbrella cloth, it lacks a special storage cavity suitable for storing the umbrella cloth by manual or automatic rotation.

### 3. SUMMARY OF THE INVENTION

The technical problem to be solved by the invention is to overcome the defect of the above technology and provide a storage cavity for a car sunshade.

In order to solve the above technical problems, the invention provides a technical scheme: a storage cavity for a car sunshade, the storage cavity comprises a lower member, an upper member, and a connector, and the storage cavity is an integrally formed structure, the two ends of the connector are respectively connected with the lower member and the upper member;

The lower member comprises a lower left arc frame, a lower right arc frame, and a lower connecting plate, the lower left arc frame and the lower right arc frame are arranged symmetrically, the adjacent ends of the lower left arc frame and the lower right arc frame are respectively connected with the connector, both ends of the lower connecting plate are respectively connected to the outer frames of the lower left arc frame and the lower right arc frame, and the lower left arc frame, the lower right arc frame, and the lower connecting plate enclose a first chamber;

The upper member comprises an upper left arc frame, an upper right arc frame, and an upper connecting plate, the upper left arc frame and the upper right arc frame are arranged symmetrically, the adjacent ends of the upper left arc frame and the upper right arc frame are respectively connected with the connector, both ends of the upper connecting plate are respectively connected to the outer frames of the upper left arc frame and the upper right arc frame, and the upper left arc frame, the upper right arc frame, and the upper connecting plate enclose a second chamber;

The upper left arc frame, the lower left arc frame, and the connector form the left storage cavity, and the upper right arc frame, the lower right arc frame, and the connector form the right storage cavity.

Further, the lower left arc frame and the lower right arc frame are respectively provided with evenly distributed through holes and positioning holes, the positioning holes are located at the ends of the lower left arc frame and the lower right arc frame away from each other.

Further, the lower member, the upper member and the connector are respectively provided with screw mounting holes.

Further, the top of the upper member is provided with a mounting slot opening.

Further, openings are opened at four corners of the top end of the upper member (2).

Further, the connector comprises a left connector and a right connector, the left connector is connected to the right connector, and the ends of them away from each other are respectively provided with open slots.

Compared with the prior art, the invention has the following advantages: the device has reasonable structure design and convenient use, the positioning holes can be used to connect with the base of vehicle-mounted sunshade, the first chamber is used to place the cleaning rod, the second chamber is used to place the telescopic rod, and the opening slots are used to place the connecting clips for connecting the umbrella cloth, the left storage cavity and right storage cavity are used to cooperate with the rotating shaft to store the umbrella cloth, and the screw mounting holes can be used to connect the mounting plates arranged on both sides.

### 4. BRIEF DESCRIPTION OF ACCOMPANY DRAWINGS

FIG. 1 is a side view of a storage cavity for a car sunshade of the invention;

FIG. 2 is a stereoscopic view 1 of a storage cavity for a car sunshade of the invention;

FIG. 3 is a stereoscopic view 2 of a storage cavity for a car sunshade of the invention;

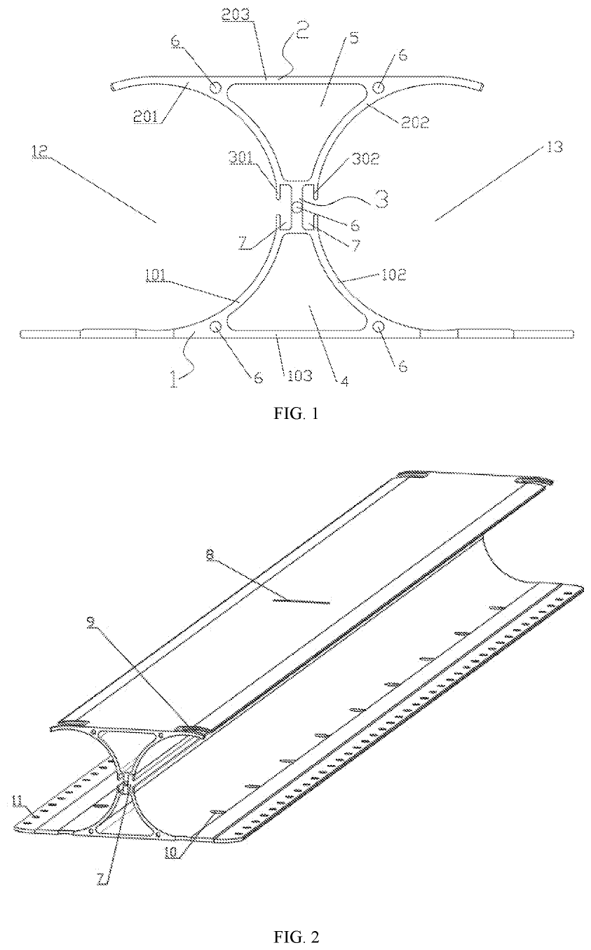

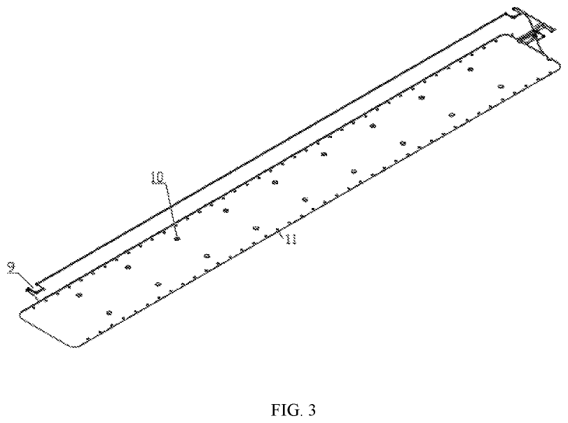

As shown in the accompanying drawings: 1 lower member, 101 lower left arc frame, 102 lower right arc frame, 103 lower connecting plate, 2 upper member, 201 upper left arc frame, 202 upper right arc frame, 203 upper connecting plate, 3 connector, 301 left connector, 302 right connector, 4 first chamber, 5 second chamber, 6 screw mounting hole, 7 open slot, 8 mounting slot opening, 9 opening, 10 through hole, 11 positioning hole, 12 left storage cavity, 13 right storage cavity.

### 5. SPECIFIC EMBODIMENT OF THE INVENTION

A storage cavity for a car sunshade of the invention will be further described below in combination with the accompanying drawings.

Combined with the accompanying drawings, a storage cavity for a car sunshade, the storage cavity comprises a lower member 1, an upper member 2, and a connector 3, and the storage cavity is an integrally formed structure, the two ends of the connector 3 are respectively connected with the lower member 1 and the upper member 2;

The lower member 1 comprises a lower left arc frame 101, a lower right arc frame 102, and a lower connecting plate 103, the lower left arc frame 101 and the lower right arc frame 102 are arranged symmetrically, the adjacent ends of the lower left arc frame 101 and the lower right arc frame 102 are respectively connected with the connector 3, both ends of the lower connecting plate 103 are respectively connected to the outer frames of the lower left arc frame 101 and the lower right arc frame 102, and the lower left arc frame 101, the lower right arc frame 102, and the lower connecting plate 103 enclose a first chamber 4;

The upper member 2 comprises an upper left arc frame 201, an upper right arc frame 202, and an upper connecting plate 203, the upper left arc frame 201 and the upper right arc frame 202 are arranged symmetrically, the adjacent ends of the upper left arc frame 201 and the upper right arc frame 202 are respectively connected with the connector 3, both ends of the upper connecting plate 203 are respectively connected to the outer frames of the upper left arc frame 201 and the upper right arc frame 202, and the upper left arc frame 201, the upper right arc frame 202, and the upper connecting plate 203 enclose a second chamber 5;

The upper left arc frame 201, the lower left arc frame 101, and the connector 3 form the left storage cavity 12, and the upper right arc frame 202, the lower right arc frame 102, and the connector 3 form the right storage cavity 13.

As the preferred embodiment of this embodiment, the lower left arc frame 101 and the lower right arc frame 102 are respectively provided with evenly distributed through holes 10 and positioning holes 11, the positioning holes 11 are located at the ends of the lower left arc frame 101 and the lower right arc frame 102 away from each other.

As the preferred embodiment of this embodiment, the lower member 1, the upper member 2 and the connector 3 are respectively provided with screw mounting holes 6, the number of the mounting holes 6 is five, which can be used as screw holes to facilitate fixation, and the shape is not limited to this shape during processing.

As the preferred embodiment of this embodiment, the top of the upper member 2 is provided with a mounting slot opening 8.

As the preferred embodiment of this embodiment, openings 9 are opened at four corners of the top end of the upper member 2, which are convenient for fingers to operate the buckles.

As the preferred embodiment of this embodiment, the connector 3 comprises a left connector 301 and a right connector 302, the left connector 301 is connected to the right connector 302, and the ends of them away from each other are respectively provided with open slots 7.

When the invention is implemented, the storage cavity comprises a lower member 1, an upper member 2, and a connector 3, and the storage cavity is an integrally formed structure, the two ends of the connector 3 are respectively connected with the lower member 1 and the upper member 2; the upper left arc frame 201, the lower left arc frame 101, and the connector 3 form the left storage cavity 12, and the upper right arc frame 202, the lower right arc frame 102, and the connector 3 form the right storage cavity 13, the left storage cavity 12 and the right storage cavity 13 are used to cooperate with the rotating shaft to store the umbrella cloth;

The positioning holes 11 can be used to connect with the base of vehicle-mounted sunshade, and the screw mounting holes 6 can be used to connect the mounting plates arranged on both sides;

The first chamber 4 is used to place the cleaning rod, the second chamber 5 is used to place the telescopic rod, and the opening slots 7 are used to place the connecting clips for connecting the umbrella cloth;

The storage cavity can be used as the basic framework for manual or automatic storage of the sunshade, providing a dedicated storage cavity for the sunshade, at the same time, the storage cavity can form a car sunshade by matching the rotating shaft of umbrella cloth, base, cleaning rod, telescopic rod, umbrella cloth of the sunshade, etc.

The invention and its embodiments are described above, this description is not restrictive, and what is shown in the accompanying drawing is only one of the embodiments of the invention, and the actual structure is not limited to this. All in all, if those skilled in the art receives its enlightenment, without deviating from the object of the invention, and without creatively designing structures and embodiments similar to the technical scheme of the invention shall fall within the protection scope of the invention.

1. A storage cavity for a car sunshade, the storage cavity comprises a lower member (1), an upper member (2), and a connector (3), and the storage cavity is an integrally formed structure, the two ends of the connector (3) are respectively connected with the lower member (1) and the upper member (2);
the lower member (1) comprises a lower left arc frame (101), a lower right arc frame (102), and a lower connecting plate (103), the lower left arc frame (101) and the lower right arc frame (102) are arranged symmetrically, the adjacent ends of the lower left arc frame (101) and the lower right arc frame (102) are respectively connected with the connector (3), both ends of the lower connecting plate (103) are respectively connected to the outer frames of the lower left arc frame (101) and the lower right arc frame (102), and the lower left arc frame (101), the lower right arc frame (102), and the lower connecting plate (103) enclose a first chamber (4);
the upper member (2) comprises an upper left arc frame (201), an upper right arc frame (202), and an upper connecting plate (203), the upper left arc frame (201) and the upper right arc frame (202) are arranged symmetrically, the adjacent ends of the upper left arc frame (201) and the upper right arc frame (202) are respectively connected with the connector (3), both ends of the upper connecting plate (203) are respectively connected to the outer frames of the upper left arc frame (201) and the upper right arc frame (202), and the upper left arc frame (201), the upper right arc frame (202), and the upper connecting plate (203) enclose a second chamber (5);
the upper left arc frame (201), the lower left arc frame (101), and the connector (3) form the left storage cavity (12), and the upper right arc frame (202), the lower right arc frame (102), and the connector (3) form the right storage cavity (13).

2. The storage cavity for a car sunshade of claim 1, the lower left arc frame (101) and the lower right arc frame (102) are respectively provided with evenly distributed through holes (10) and positioning holes (11), the positioning holes (11) are located at the ends of the lower left arc frame (101) and the lower right arc frame (102) away from each other.

3. The storage cavity for a car sunshade of claim 1, the lower member (1), the upper member (2) and the connector (3) are respectively provided with screw mounting holes (6).

4. The storage cavity for a car sunshade of claim 1, the top of the upper member (2) is provided with a mounting slot opening (8).

5. The storage cavity for a car sunshade of claim 1, openings (9) are opened at four corners of the top end of the upper member (2).

6. The storage cavity for a car sunshade of claim 1, the connector (3) comprises a left connector (301) and a right connector (302), the left connector (301) is connected to the right connector (302), and the ends of them away from each other are respectively provided with open slots (7).
